(19) United States
(12) Patent Application Publication
(10) Pub. No.: US 2017/0241294 A1
(43) Pub. Date: Aug. 24, 2017

(54) EXHAUST SYSTEM FOR GAS TURBINE ENGINE

(71) Applicant: Solar Turbines Incorporated, San Diego, CA (US)

(72) Inventors: Ulrich E. Stang, Solana Beach, CA (US); Wing F. Ng, Blacksburg, VA (US); Stephen A. Guillot, Blacksburg, VA (US); Nihar R. Samal, San Diego, CA (US)

(73) Assignee: Solar Turbines Incorporated, San Diego, CA (US)

(21) Appl. No.: 15/046,946

(22) Filed: Feb. 18, 2016

(51) Int. Cl. F01D 25/30; F01D 9/02; F01D 5/02; F02C 3/04

(52) U.S. Cl. CPC F01D 25/30; F02C 3/04; F01D 9/02; F01D 5/02; F05D 2220/32; F05D 2240/35

(57) ABSTRACT

An exhaust system for a gas turbine engine is provided. The exhaust system includes an exhaust diffuser having a diffuser axis. The exhaust diffuser includes an outer diffuser wall. The exhaust diffuser also includes an inner diffuser wall. The exhaust diffuser further includes a diffuser inlet formed by the first and second upstream ends of the outer diffuser wall and the inner diffuser wall. The exhaust diffuser includes a diffuser exit. The exhaust system also includes an exhaust collector coupled with the exhaust diffuser and adapted to collect and redirect exhaust gases in a radial direction. The exhaust collector includes a circumferential wall. The exhaust collector also includes a forward wall. The exhaust collector further includes an aft wall, wherein the aft wall is angled with respect to the diffuser axis. The exhaust collector includes a splitter disposed between the forward wall and the aft wall of the exhaust collector.

### TECHNICAL FIELD

The present disclosure relates to an exhaust system for a gas turbine engine, and more particularly to an exhaust system having an exhaust diffuser and an exhaust collector.

### BACKGROUND

Generally, the gas turbine engine includes an inlet, a compressor, a combustor, a turbine and an exhaust system. The combustor and the turbine are in fluid communication with the exhaust system, and generate high-temperature, high-velocity exhaust gases. The exhaust system of the gas turbine engine includes an exhaust diffuser and an exhaust collector. The exhaust diffuser provides an increase in flow area resulting in a reduction in the velocity of the exhaust gases which, in turn, leads to an increase in static pressure along its flow path. Because of this pressure recovery in the exhaust diffuser, the inlet-to-exit pressure ratio of the turbine is increased, resulting in an increase in both output power and thermal efficiency. Additionally, the exhaust collector serves to redirect the exhaust gases away from downstream equipment or towards site-specific interfaces.

U.S. Pat. No. 6,261,055 describes an annular diffuser having its inlet located at the exit of a last row of blades of a steam turbine having initially very slowly increasing cross-sectional area with distance to accommodate the diffusion produced by the decaying wakes in the diffuser so as to prevent flow separation from diffuser walls and as a result to foster the diffusion process and to increase the efficiency of the steam turbine. The rate of increase of cross-sectional area, which is much smaller than that appropriate in diffusers having uniform incompressible flow at their inlets, allows wakes which form near the trailing edges of the last turbine blades to dissipate while avoiding flow separation. In the diffuser of this invention, whether it is one of fixed shape or one whose cross-sectional area can be changed by making use of an adjustable guide vane which surrounds at least a portion of the bearing cone, at a distance from inlet of one half of diffuser height at inlet, the cross-sectional area increase is smaller than 5.0% of the inlet cross-sectional area.

### SUMMARY OF THE DISCLOSURE

In one aspect of the present disclosure, an exhaust system for a gas turbine engine is provided. The exhaust system includes an exhaust diffuser having a diffuser axis. The exhaust diffuser includes an outer diffuser wall having a first upstream end and a first flared downstream portion. The exhaust diffuser also includes an inner diffuser wall positioned radially within the outer diffuser wall, the inner diffuser wall having a second upstream end and a second flared downstream portion. The exhaust diffuser further includes a diffuser inlet formed by the first and second upstream ends of the outer diffuser wall and the inner diffuser wall. The exhaust diffuser includes a diffuser exit formed by the first flared downstream portion of the outer diffuser wall and the second flared downstream portion of the inner diffuser wall. The exhaust system also includes an exhaust collector coupled with the exhaust diffuser and adapted to collect and redirect exhaust gases in a radial direction. The exhaust collector includes a circumferential wall encircling the diffuser exit about the diffuser axis. The exhaust collector also includes a forward wall radially extending inwards from the circumferential wall and connected to the outer diffuser wall. The exhaust collector further includes an aft wall radially extending inwards from the circumferential wall and connected to the inner diffuser wall, wherein the aft wall is angled with respect to the diffuser axis. The exhaust collector includes a splitter disposed between the forward wall and the aft wall of the exhaust collector.

In another aspect of the present disclosure, an exhaust collector for an exhaust system of a gas turbine engine is provided. The exhaust collector is coupled with an exhaust diffuser and adapted to collect and redirect exhaust gases in a radial direction. The exhaust collector includes a circumferential wall encircling a diffuser exit of the exhaust diffuser. The exhaust collector also includes a forward wall radially extending inwards from the circumferential wall and connected to an outer diffuser wall of the exhaust diffuser. The exhaust collector further includes an aft wall radially extending inwards from the circumferential wall and connected to an inner diffuser wall of the exhaust diffuser, wherein the aft wall is angled with respect to the diffuser axis. The exhaust collector includes a splitter disposed between the forward wall and the aft wall of the exhaust collector.

In yet another aspect of the present disclosure, a gas turbine engine is provided. The gas turbine engine includes a compressor configured to receive a working fluid for compression thereof. The gas turbine engine also includes a combustor in fluid communication with the compressor. The combustor is configured to receive a compressed working fluid from the compressor. The gas turbine engine further includes a turbine positioned downstream of the combustor with respect to a flow direction of the compressed working fluid. The gas turbine engine includes an exhaust system. The exhaust system includes an exhaust diffuser having a diffuser axis. The exhaust diffuser includes an outer diffuser wall having a first upstream end and a first flared downstream portion. The exhaust diffuser also includes an inner diffuser wall positioned radially within the outer diffuser wall, the inner diffuser wall having a second upstream end and a second flared downstream portion. The exhaust diffuser further includes a diffuser inlet formed by the first and second upstream ends of the outer diffuser wall and the inner diffuser wall. The exhaust diffuser includes a diffuser exit formed by the first flared downstream portion of the outer diffuser wall and the second flared downstream portion of the inner diffuser wall. The exhaust system also includes an exhaust collector coupled with the exhaust diffuser and adapted to collect and redirect exhaust gases in a radial direction. The exhaust collector includes a circumferential wall encircling the diffuser exit about the diffuser axis. The exhaust collector also includes a forward wall radially extending inwards from the circumferential wall and connected to the outer diffuser wall. The exhaust collector further includes an aft wall radially extending inwards from the circumferential wall and connected to the inner diffuser wall, wherein the aft wall is angled with respect to the diffuser axis. The exhaust collector includes a splitter disposed between the forward wall and the aft wall of the exhaust collector.

Other features and aspects of this disclosure will be apparent from the following description and the accompanying drawings.

### BRIEF DESCRIPTION OF THE DRAWINGS

FIG. 1 is a schematic view of an exemplary gas turbine engine, according to one embodiment of the present disclosure;

FIG. 2 is a cross-sectional view of the exhaust system of the gas turbine engine, according to one embodiment of the present disclosure; and

FIG. 3 is a perspective view of an exhaust system of the gas turbine engine.

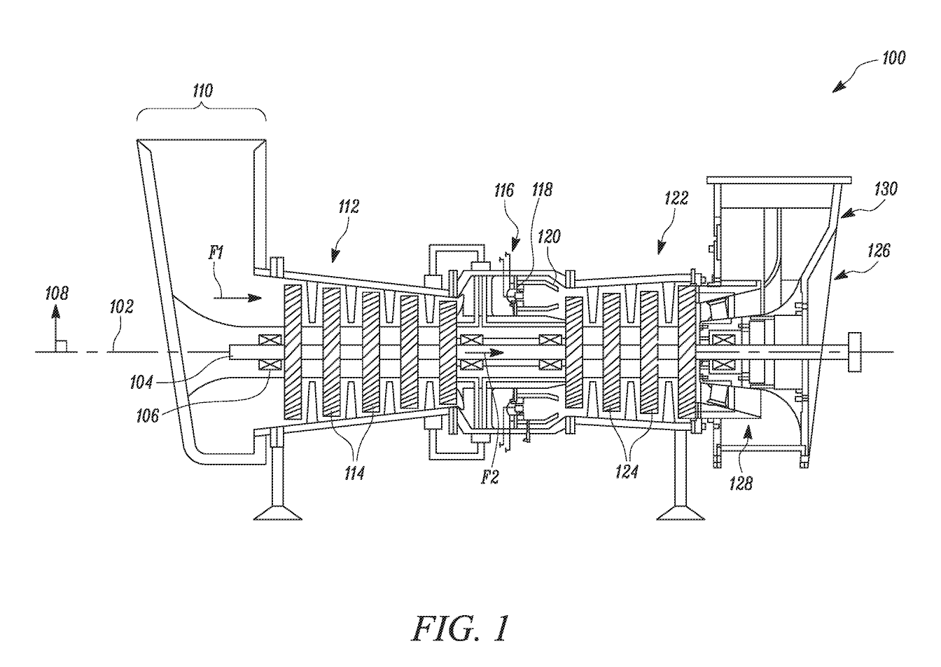

### DETAILED DESCRIPTION

Wherever possible, the same reference numbers will be used throughout the drawings to refer to the same or the like parts. FIG. 1 is a schematic view of an exemplary gas turbine engine 100, according to one embodiment of the present disclosure. The embodiments described below are not limited to use in conjunction with a particular type of gas turbine engine, but rather may be applied to stationary or motive gas turbine engines, or any variant thereof. As applied, gas turbine engines, and thus their components, may be suited for any number of industrial applications, such as, but not limited to, various aspects of the oil and natural gas industry (including include transmission, gathering, storage, withdrawal, and lifting of oil and natural gas), power generation industry, aerospace and transportation industry, and the like.

Some of the surfaces of the gas turbine engine 100 have been left out or exaggerated (here and in other figures) for clarity and ease of explanation. Also, the disclosure will generally reference a center axis 102 of rotation of the gas turbine engine 100, which may be generally defined by the longitudinal axis of its shaft 104 that is supported by a number of bearing assemblies 106. The center axis 102 may be common to or shared with various other engine concentric components. All references to radial, axial, and circumferential directions and measures refer to the center axis 102, unless specified otherwise, and terms such as “inner” and “outer” generally indicate a lesser or greater radial distance from the center axis 102, wherein a radial direction 108 may be in any direction perpendicular and extending outward from the center axis 102.

In addition, the disclosure may reference a “forward” and an “aft” direction. Generally, all references to “forward” and “aft” are associated with a flow direction “F1” of a primary working fluid, hereinafter interchangeably referred to as the working fluid. The working fluid is air used in the combustion process, unless specified otherwise. For example, forward is “upstream” relative to the working fluid i.e., towards the point where the working fluid enters the system. Whereas, aft is “downstream” relative to the working fluid i.e., towards the point where the working fluid leaves the system.

The gas turbine engine 100 includes an inlet 110. The inlet 110 is in fluid communication with a compressor 112. The compressor 112 includes one or more compressor rotor assemblies 114. The compressor 112 receives the working fluid from the inlet 110 and compresses it to a higher pressure. More particularly, the working fluid is compressed in an annular flow path defined by the compressor rotor assemblies 114.

The gas turbine engine 100 includes a combustor 116. The combustor 116 is in fluid communication with the compressor 112. The combustor 116 is positioned downstream of the compressor 112. The combustor 116 receives a compressed working fluid from the compressor 112. The compressed working fluid leaves the compressor 112 and enters the combustor 116, where it is diffused and fuel is added. The combustor 116 includes one or more injectors 118 and one or more combustion chambers 120. The fuel and the compressed working fluid are injected into the combustion chamber 120 via the injectors 118 and are ignited, thereby generating energy.

The gas turbine engine 100 includes a turbine 122. The turbine 122 is in fluid communication with the combustor 116. The turbine 122 is positioned downstream of the combustor 116 with respect to a flow direction “F2” of the compressed working fluid. The turbine 122 includes one or more turbine rotor assemblies 124. After the combustion reaction in the combustor 116, the generated energy is extracted from the combusted fuel/air mixture via the turbine 122 by the series of the turbine rotor assemblies 124.

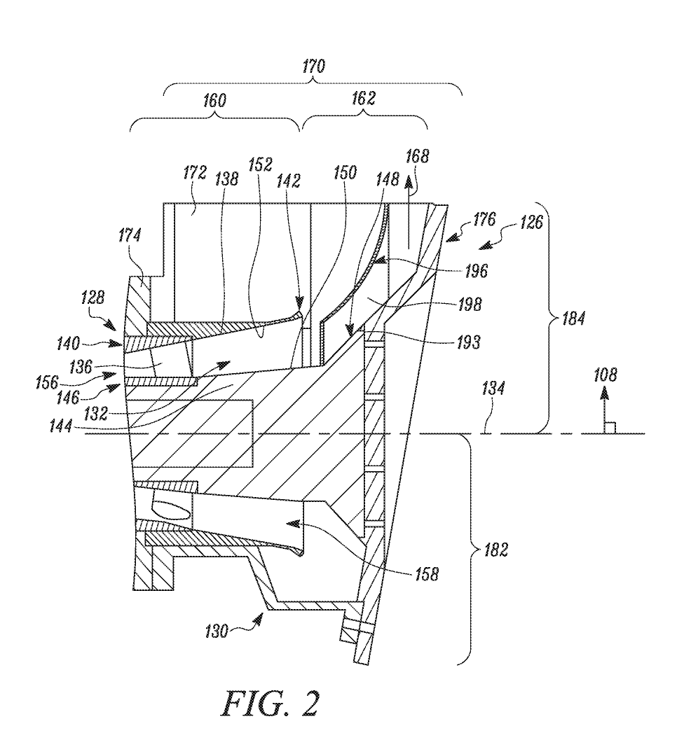

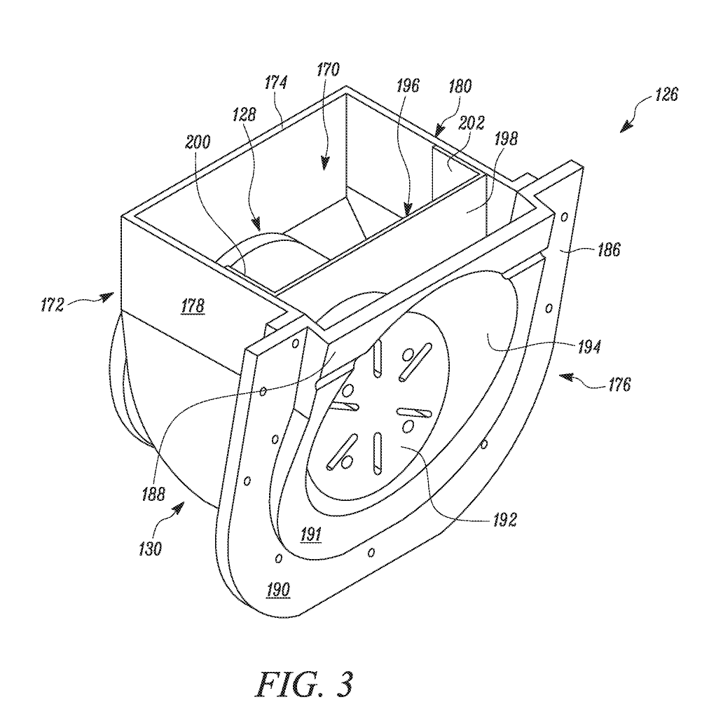

The gas turbine engine 100 includes an exhaust system 126. The exhaust system 126 is in fluid communication with the turbine 122. The exhaust system 126 is adapted to receive exhaust gases from the turbine 122. Referring to FIGS. 2 and 3, the exhaust system 126 includes an exhaust diffuser 128 and an exhaust collector 130. The exhaust gases are diffused in the exhaust diffuser 128. The exhaust diffuser 128 is an axial-radial diffuser configured to pneumatically couple with and form a flow path between the turbine 122 and the exhaust collector 130.

Referring to FIG. 2, the exhaust diffuser 128, in general, may be conceptualized as two concentric structures (e.g., tubes) having a diffuser axis 134, joined to each other via a plurality of strut rings 136 circumferentially distributed around the diffuser axis 134. The diffuser axis 134 may coincide with the center axis 102 when the exhaust diffuser 128 is installed onto the gas turbine engine 100. Accordingly, when installed, the flow path may be an annular exhaust flow path between the turbine 122 and the exhaust collector 130, interrupted by only the strut rings 136 themselves.

The exhaust diffuser 128 includes an outer diffuser wall 138 and an inner diffuser wall 144 forming the concentric structures. The outer diffuser wall 138 and the inner diffuser wall 144 are embodied as tubular members circumscribing the diffuser axis 134. The outer diffuser wall 138 includes a first upstream end 140 and a first flared downstream portion 142. According to one embodiment, the exhaust diffuser 128 may be offset with respect to the diffuser axis 134.

The inner diffuser wall 144 includes a second upstream end 146 and a second flared downstream portion 148. At the second upstream end 146, the inner diffuser wall 144 is positioned radially within the outer diffuser wall 138. At the second flared downstream portion 148, the inner diffuser wall 144 extends axially beyond the outer diffuser wall 138.

The inner diffuser wall 144 and the outer diffuser wall 138 may be joined together by the number of strut rings 136 extending therebetween. The strut rings 136 are disposed between the outer diffuser wall 138 and the inner diffuser wall 144. According to one embodiment, the inner diffuser wall 144 and the outer diffuser wall 138 may be at least partially concentric.

The outer diffuser wall 138 and the inner diffuser wall 144 form a flow path 132. In particular, an outer surface 150 of the inner diffuser wall 144 and an inner surface 152 of the outer diffuser wall 138 form the annular flow path 132. As the flow path 132 advances downstream it transitions from a predominantly annular shape to a predominantly circumferential band shape directed radially outward.

As shown in the accompanying figure, the exhaust diffuser 128 includes a diffuser inlet 156. The exhaust diffuser 128 receives the exhaust gases in the axial direction from the turbine 122 via the diffuser inlet 156. The diffuser inlet 156 is formed by the first and the second upstream ends 140, 146 of the outer diffuser wall 138 and the inner diffuser wall 144, respectively. In particular, the diffuser inlet 156 may be an annular opening formed by concentric upstream ends 140, 146 of the outer diffuser wall 138 and the inner diffuser wall 144, respectively.

The exhaust diffuser 128 also includes a diffuser exit 158. The exhaust diffuser 128 discharges the exhaust gases in the radial direction 108 into the exhaust collector 130 via the diffuser exit 158. Further, the diffuser exit 158 is formed by the first flared downstream portion 142 of the outer diffuser wall 138 and the second flared downstream portion 148 of the inner diffuser wall 144. The diffuser exit 158 may be a circumferential band opening formed by an axial displacement of the first flared downstream portion 142 and the second flared downstream portion 148.

The components of the exhaust diffuser 128 may be manufactured using any manufacturing process known in the art. In one example, each of the outer diffuser wall 138, the inner diffuser wall 144, and the strut rings 136 may be manufactured as separate parts, and later assembled to form the exhaust diffuser 128. In an alternate example, the exhaust diffuser 128 may be manufactured as a single unitary component by a manufacturing process including, but not limited to, casting, molding, and the like.

The exhaust diffuser 128 may include a linear diffusion region 160 followed by a turning region 162. The linear diffusion region 160 be shaped as an annular conical frustum, or the like, configured to increase the effective flow area between the inner diffuser wall 144 and the outer diffuser wall 138 from the diffuser inlet 156 to the turning region 162. In particular, the effective flow area may increase relative to the operation conditions of the exhaust gases so as to increase recovery and inhibit separation. For example, the effective flow area may be increased along the flow path 132 by increasing the distance between the diffuser inlet 156 and the diffuser exit 158 with respect to the flow path 132. Also for example, the effective flow area may be increased along the flow path 132 by increasing the average circumference of the flow path 132.

According to one embodiment, the linear diffusion region 160 may include a canted flow path. In particular, the inner diffuser wall 144 may form a conical frustum about the center axis 102. For example, the inner diffuser wall 144 may be angled between 0 degrees to 15 degrees away from the center axis 102 in a downstream direction. Also for example, the inner diffuser wall 144 may be angled between 3 degrees to 10 degrees away from the center axis 102 in the downstream direction. Also, in one example, the inner diffuser wall 144 may be angled approximately 5 degrees away from the diffuser axis 134 in the downstream direction. The turning region 162 is a curved region beginning at the end of the linear diffusion region 160 and terminating downstream at the diffuser exit 158. The turning region 162 is configured to add a radial component to the velocity vector of the exhaust gases and turn the exhaust gases from a predominantly axial flow to a predominantly radial flow.

Referring to FIGS. 2 and 3, the exhaust collector 130 of the exhaust system 126 is a radial exhaust collector configured to couple with the exhaust diffuser 128. The exhaust collector 130 collects the exhaust gases, and redirects it radially away in a single, convenient discharge direction 168 away from the gas turbine engine 100. In one embodiment, the exhaust collector 130 is an enclosure wrapping around the exhaust diffuser 128 and having a single opening in the radial direction 108 for discharge of the exhaust gases. Here, the exhaust collector 130 is configured to radially receive the exhaust gases and redirect it radially upward, or along a discharge direction 168. The exhaust collector 130 discharges the exhaust gases in the discharge direction 168 away from the gas turbine engine 100 via an exhaust collector exit 170.

The exhaust collector 130 includes a circumferential wall 172, a forward wall 174, and an aft wall 176. The circumferential wall 172 may be bound on a forward side by the forward wall 174 and on an aft side by the aft wall 176. Together, the circumferential wall 172, the forward wall 174, and the aft wall 176 enclose the diffuser exit 158 such that the exhaust gases are directed towards the exhaust collector exit 170.

The circumferential wall 172 may encircle a majority of the diffuser exit 158, about the center axis 102, and be sufficiently offset to accept flow from the diffuser exit 158. The circumferential wall 172 is substantially U-shaped. The circumferential wall 172 includes a first wall 178 and a second wall 180. In one example, the first and second walls 178, 180 are parallel to each other. Further, the forward wall 174 of the exhaust collector 130 radially extends inwards from the circumferential wall 172. The forward wall 174 is connected to the outer diffuser wall 138. In the illustrated embodiment, the forward wall 174 of the exhaust collector 130 is substantially perpendicular to the diffuser axis 134. In another example, the forward wall 174 of the exhaust collector 130 may be slanted with respect to the diffuser axis 134, without limiting the scope of the present disclosure.

Referring to FIG. 2, the exhaust collector 130 includes the aft wall 176. The aft wall 176 radially extends inwards from the circumferential wall 172. Further, the aft wall 176 is connected to the inner diffuser wall 144. The aft wall 176 is angled with respect to the diffuser axis 134. More particularly, a lower portion 182 of the aft wall 176 of the exhaust collector 130 is disposed proximate to the forward wall 174 compared to an upper portion 184 of the aft wall 176, with respect to the diffuser axis 134. In one example, the aft wall 176 is coupled to the circumferential wall 172. Mechanical fasteners, such as bolt, stud, rivet, pin, and the like, may be used to couple the aft wall 176 with the circumferential wall 172.

Referring to FIG. 3, the aft wall 176 includes a flange portion 186. The flange portion 186 receives the mechanical fasteners to couple the aft wall 176 with the circumferential wall 172. The aft wall 176 also includes a projecting wall portion 188. The projecting wall portion 188 is inclined with respect to the flange portion 186 of the aft wall 176. A distance between a top surface 190 of the flange portion 186 and a top surface 191 of the projecting wall portion 188 decreases from the upper portion 184 of the aft wall 176 towards the lower portion 182 of the aft wall. Further, the aft wall 176 includes a circular wall portion 192. The circular wall portion 192 is in contact with an outer periphery 193 (see FIG. 2) of the inner diffuser wall 144. The circular wall portion 192 is parallel to the forward wall 174 of the exhaust collector 130. Further, a side wall portion 194 of the aft wall 176 connects the circular wall portion 192 with the projecting wall portion 188.

Together, the forward wall 174, the circumferential wall 172, and the aft wall 176 form the exhaust collector exit 170. In particular, the exhaust collector exit 170 may be an opening formed by the upstream ends of the forward wall 174, the circumferential wall 172, and the aft wall 176. For example, the upstream ends of the forward wall 174, the circumferential wall 172, and the aft wall 176 may be joined, forming a single path to exit the enclosure. The exhaust collector exit 170 may be of any convenient shape and orientation to the discharge direction 168. For example and as illustrated, the exhaust collector exit 170 may have a generally rectangular shape that is normal to the discharge direction 168.

The exhaust collector 130 also includes the splitter 196. The splitter 196 is movably disposed along the diffuser axis 134. The splitter 196 is positioned at the diffuser exit 158. The splitter 196 is coupled to the circumferential wall 172 and is disposed between the forward wall 174 and the aft wall 176 of the exhaust collector 130. More particularly, the splitter 196 is coupled to the first wall 178 and the second wall 180 of the circumferential wall 172, respectively. In one example, the splitter 196 may be coupled to each of the first wall 178 and the second wall 180 of the circumferential wall 172 using mechanical fasteners. The mechanical fasteners may include any one of a bolt, pin, rivet, stud, and the like.

The splitter 196 includes a vane member 198 (see FIG. 2), a first side portion 200, and a second side portion 202. The first and second side portions 200, 202 respectively couple with the first wall 178 and the second wall 180 of the circumferential wall 172, respectively. Further, the vane member 198 of the splitter 196 connects the first side portion 200 and the second side portion 202. In one example, the vane member 198 is disposed between the first and second flared downstream portions 142, 148 of the outer diffuser wall 138 and the inner diffuser wall 144 respectively.

It should be noted that the components of the exhaust diffuser 128 and the exhaust collector 130 may be made from any metal or non-metal known in the art. One or more of the components (or their subcomponents) may be made from stainless steel and/or durable, high temperature materials known as “superalloys”. A superalloy, or high-performance alloy, is an alloy that exhibits excellent mechanical strength and creep resistance at high temperatures, good surface stability, and corrosion and oxidation resistance. Superalloys may include materials such as HASTELLOY, INCONEL, WASPALOY, RENE alloys, HAYNES alloys, INCOLOY, MP98T, TMS alloys, CMSX single crystal alloys, Alloy X, Alloy 188/230, and the like, without limiting the scope of the present disclosure.

### INDUSTRIAL APPLICABILITY

The present disclosure relates to the exhaust system 126 having the exhaust diffuser 128 and the exhaust collector 130. The exhaust collector 130 includes the angled aft wall 176 and the splitter 196. Incorporation of the exhaust system 126 disclosed above contributes in increasing an overall performance and efficiency of the gas turbine engine 100. Also, the design of the exhaust system 126 decreases maintenance and repair, and/or lower costs associated with the gas turbine engine 100. Further, the exhaust system 126 disclosed above may result in increased turbine pressure ratio, leading to more shaft power, higher efficiency, and/or lower operating costs. The exhaust system 126 also improves durability and reduction in noise signature due to the uniform introduction of exhaust gases into the exhaust collector 130.

Further, the splitter 196 provides an opportunity to optimize turbine performance for specific operating points and ambient conditions, and seasonal operations. For example, if a customer operates the gas turbine engine 100 mainly at off load, say 50% power, the splitter 196 could be adjusted at factory to facilitate such a condition. Conversely, if the gas turbine engine 100 is installed in an area with large seasonal variations in operating conditions, a field service personnel may adjust the splitter 196 for optimum performance.

The exhaust system 126 is equally applicable at any stage of the gas turbine engine's life, from design to prototyping and first manufacture, and onward to end-of-life. Further, the exhaust system 126 may be used as a retrofit or enhancement to existing gas turbine engine, as a preventative measure, or even in response to an event. Moreover, the various combined features may be adapted to retrofit a previous design as the presently disclosed exhaust system 126 may be installed in a gas turbine engine having identical interfaces to another exhaust system so as to be interchangeable with an earlier type of exhaust system.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An exhaust system for a gas turbine engine, the exhaust system comprising:
an exhaust diffuser having a diffuser axis, the exhaust diffuser comprising:
an outer diffuser wall having a first upstream end and a first flared downstream portion; and
an inner diffuser wall positioned radially within the outer diffuser wall, the inner diffuser wall having a second upstream end and a second flared downstream portion;
a diffuser inlet formed by the first and the second upstream ends of the outer diffuser wall and the inner diffuser wall; and
a diffuser exit formed by the first flared downstream portion of the outer diffuser wall and the second flared downstream portion of the inner diffuser wall; and
an exhaust collector coupled with the exhaust diffuser and adapted to collect and redirect exhaust gas in a radial direction, the exhaust collector comprising:
a circumferential wall encircling the diffuser exit about the diffuser axis;
a forward wall radially extending inwards from the circumferential wall and connected to the outer diffuser wall;
an aft wall radially extending inwards from the circumferential wall and connected to the inner diffuser wall, wherein the aft wall is angled with respect to the diffuser axis; and
a splitter disposed between the forward wall and the aft wall of the exhaust collector.

2. The exhaust system of claim 1, wherein a lower portion of the aft wall of the exhaust collector is disposed proximate to the forward wall than an upper portion of the aft wall.

3. The exhaust system of claim 1, wherein the splitter is coupled to the circumferential wall.

4. The exhaust system of claim 1, wherein the splitter is movable along the diffuser axis.

5. The exhaust system of claim 1, wherein the forward wall of the exhaust collector is slanted with respect to the diffuser axis.

6. The exhaust system of claim 1, wherein the forward wall of the exhaust collector is substantially perpendicular to the diffuser axis.

7. The exhaust system of claim 1, wherein the diffuser inlet is an annular opening formed by the first and the second upstream ends of the outer diffuser wall and the inner diffuser wall.

8. The exhaust system of claim 1, wherein the diffuser exit is a circumferential band opening formed by the first flared downstream portion of the outer diffuser wall and the second flared downstream portion of the inner diffuser wall.

9. An exhaust collector for an exhaust system of a gas turbine engine, the exhaust collector coupled with an exhaust diffuser and adapted to collect and redirect exhaust gas in a radial direction, the exhaust collector comprising:
a circumferential wall encircling a diffuser exit of the exhaust diffuser;
a forward wall radially extending inwards from the circumferential wall and connected to an outer diffuser wall of the exhaust diffuser;
an aft wall radially extending inwards from the circumferential wall and connected to an inner diffuser wall of the exhaust diffuser, wherein the aft wall is angled with respect to the diffuser axis; and
a splitter disposed between the forward wall and the aft wall of the exhaust collector.

10. The exhaust collector of claim 9, wherein a lower portion of the aft wall of the exhaust collector is disposed proximate to the forward wall than an upper portion of the aft wall.

11. The exhaust collector of claim 9, wherein the splitter is coupled to the circumferential wall.

12. The exhaust collector of claim 9, wherein the splitter is movable along the diffuser axis.

13. The exhaust collector of claim 9, wherein the forward wall of the exhaust collector is substantially perpendicular to the diffuser axis of the exhaust diffuser.

14. A gas turbine engine comprising:
a compressor configured to receive a working fluid for compression thereof;
a combustor in fluid communication with the compressor, the combustor configured to receive a compressed working fluid from the compressor;
a turbine positioned downstream of the combustor with respect to a flow direction of the compressed working fluid; and
an exhaust system configured to receive exhaust gas from the turbine, the exhaust system comprising:
an exhaust diffuser having a diffuser axis, the exhaust diffuser comprising:
an outer diffuser wall having a first upstream end and a first flared downstream portion; and
an inner diffuser wall positioned radially within the outer diffuser wall, the inner diffuser wall having a second upstream end and a second flared downstream portion;
a diffuser inlet formed by the first and the second upstream ends of the outer diffuser wall and the inner diffuser wall; and
a diffuser exit formed by the first flared downstream portion of the outer diffuser wall and the second flared downstream portion of the inner diffuser wall; and
an exhaust collector coupled with the exhaust diffuser and adapted to collect and redirect exhaust gas in a radial direction, the exhaust collector comprising:
a circumferential wall encircling the diffuser exit about the diffuser axis;
a forward wall radially extending inwards from the circumferential wall and connected to the outer diffuser wall; an aft wall radially extending inwards from the circumferential wall and connected to the inner diffuser wall, wherein the aft wall is angled with respect to the diffuser axis; and
a splitter disposed between the forward wall and the aft wall of the exhaust collector.

15. The gas turbine engine of claim 14, wherein a lower portion of the aft wall of the exhaust collector is disposed proximate to the forward wall than an upper portion of the aft wall.

16. The gas turbine engine of claim 14, wherein the splitter is coupled to the circumferential wall.

17. The gas turbine engine of claim 14, wherein the splitter is movable along the diffuser axis.

18. The gas turbine engine of claim 14, wherein the forward wall of the exhaust collector is slanted with respect to the diffuser axis.

19. The gas turbine engine of claim 14, wherein the forward wall of the exhaust collector is substantially perpendicular to the diffuser axis.

20. The gas turbine engine of claim 14, wherein the diffuser inlet is an annular opening formed by the first and the second upstream ends of the outer diffuser wall and the inner diffuser wall, and the diffuser exit is a circumferential band opening formed by the first flared downstream portion of the outer diffuser wall and the second flared downstream portion of the inner diffuser wall.
